(19) United States
(12) Patent Application Publication
(10) Pub. No.: US 2004/0015574 A1
(43) Pub. Date: Jan. 22, 2004

(54) Multimedia communication management system with external system management

(75) Inventor: Robert F. Meyerson, Naples, FL (US)

Correspondence Address: TIMOTHY P. O'HAGAN, 8710 KILKENNY CT, FORT MYERS, FL, 33912, US

(73) Assignee: Teleware, Inc., Akron, OH

(21) Appl. No.: 10/620,643

(22) Filed: Jul. 16, 2003

Related U.S. Application Data
(63) Continuation-in-part of application No. 10/000,543, filed on Oct. 23, 2001.
(63) Continuation-in-part of application No. 09/961,532, filed on Sep. 24, 2001.

(51) Int. Cl. G06F 15/177

(52) U.S. Cl. 709/220

(57) ABSTRACT

One aspect of the invention provides a method performed by the control unit for controlling external electronic systems coupled to a LAN. One embodiment of the method includes receiving a first signal from a first subscriber station. Responsive to the first signal, the method forwards a tagged subscriber station message to the first subscriber station. The tagged subscriber station message is applicable to the subscriber interface of the first subscriber station. The method receives a second signal from the first subscriber station based at least in part on the tagged subscriber station message. The method forwards a tagged external system message that includes a control command to at least one external system based at least in part on the second signal from the first subscriber station. After forwarding a tagged external system message to the at least one external system, the method can further include receiving a tagged external system message that includes status information back from the at least one external system

### CROSS-REFERENCE TO RELATED ACTIONS

This application claims the benefit of, and is a continuation in part of U.S. patent application Ser. No. 10/000,543 filed on Oct. 23, 2001, entitled “Modular Multi-Media Communication Management System,” that is a continuation in part of U.S. patent application Ser. No. 09/961,532 entitled “Teledata Space and Docking Station with Modular and Integrated Display” filed on Sep. 24, 2001, the contents of both such patent applications being incorporated herein.

### FIELD OF THE INVENTION

The invention relates generally to managing external systems, and more particularly to a modular system for managing electronic systems, such as an alarm system, a heating/air-conditioning system, and/or an audio/visual electronic system, that are external to a subscriber station but coupled to a local area network.

### BACKGROUND OF THE INVENTION

Any individual location such as a home or business can incorporate a large number of electronic systems such as an alarm system, a heating/air-conditioning system, and an audio/visual system. Typically one has to manage each system from a separate controller usually located in proximity to the system being managed.

Some electronic systems such as some alarm systems may be capable of remote management. However, the systems typically require a dedicated management device or methodology. In other words, one cannot use the same remote management device or methodology to manage a wide variety of electronic systems.

Thus, one cannot manage a variety of external systems using one device. Furthermore, one cannot manage a variety of systems from a variety of locations. In addition, one cannot manage a variety of external systems using existing infrastructure. A need exists for systems and methods for managing external electronic systems that do not suffer the disadvantages of existing management systems.

### SUMMARY OF THE INVENTION

The invention is related to the use of a subscriber station to control external systems such as an alarm system, a heating/air-conditioning system, and an audio/visual electronic system. A subscriber station is a tele-data system in communication with a control unit over a network. An external system refers to an electronic system external to a subscriber station but coupled to a local area network.

According to one embodiment, each external system is configured to receive tagged, e.g., XML, messages that include control commands over a local area network from a control unit and to provide XML messages that include system status information (e.g. ambient status, operational alarms, etc.) upon query from the control unit.

The control unit includes system control software (as part of the session control server). The system control software interfaces with an external system over the local area network using tagged external system messages. The control unit interfaces with a subscriber station using tagged subscriber station messages. The tagged subscriber station messages can include HTML documents (and http posts) or XML messages with style sheets that are applicable for the subscriber interface of the subscriber station in question.

One aspect of the invention provides a control system for controlling external systems coupled to a local area network. The control system includes a control unit and a first subscriber station. The control unit is coupled to the LAN and includes system control software. The system control software forwards a tagged external system message that includes a control command to at least one external system and receives a tagged external system message that includes status information back from the at least one external system upon query from the control unit. The first subscriber station is in communication with the control unit over a network. The first subscriber station interfaces with the control unit using tagged subscriber station messages. The tagged subscriber station messages are applicable to a subscriber interface of the first subscriber station.

Another aspect of the invention provides a method performed by a control unit for controlling external electronic systems coupled to a LAN. One embodiment of the method includes receiving a first signal from a first subscriber station. Responsive to the first signal, the method forwards a tagged subscriber station message to the first subscriber station. The tagged subscriber station message is applicable to the subscriber interface of the first subscriber station. The method receives a second signal from the first subscriber station based at least in part on the tagged subscriber station message, and the method forwards a tagged external system message that includes a control command to at least one external system based at least in part on the second signal from the first subscriber station. After forwarding a tagged external system message to the at least one external system, the method can further include receiving a tagged external system message that includes status information back from the at least one external system. Such a method advantageously allows a subscriber to manage external systems such as an alarm system or heating system from one device and from a variety of locations.

These and other advantages of the invention, along with the invention itself, will be more fully understood after a review of the following figures, detailed description, and claims.

### BRIEF DESCRIPTION OF THE FIGURES

FIG. 1 is a block diagram view of a modular external system management system in accordance with one embodiment of the present invention;

FIG. 2a is a block diagram of an external system management system controller in accordance with one embodiment of the present invention;

FIG. 2b is a block diagram of a system control component located in the web server application of the controller of FIG. 2a;

FIG. 3 is a perspective exploded view of a modular subscriber station in accordance with one embodiment of the present invention;

FIG. 4 is a block diagram of a subscriber station in accordance with one embodiment of the present invention;

FIG. 5 is a block diagram of a subscriber data assistant in accordance with one embodiment of the present invention;

FIG. 6 is a block diagram of a wide area network communication device in accordance with one embodiment of the present invention;

FIG. 7 is a block diagram of a wireless dialog handset in accordance with one embodiment of the present invention;

FIG. 8a is a table diagram representing a current network location table in accordance with one embodiment of the present invention;

FIG. 8b is a table diagram representing a manage external system(s) table in accordance with one embodiment of the invention;

FIGS. 9a through 9e each show a flow chart representing processing steps performed by an external system management system in accordance with one embodiment of the present invention;

FIGS. 10a through 10h each show an exemplary display of information to a subscriber utilizing a subscriber interface of a subscriber station in accordance with one embodiment of the present invention; and

FIG. 11 shows a flow chart representing exemplary operation of packet audio/video gateway in accordance with one embodiment of the present invention.

### DETAILED DESCRIPTION OF PREFERRED EMBODIMENTS

The present invention is now described in detail with reference to the drawings. In the drawings, each element with a reference number is similar to other elements with the same reference number independent of any letter designation following the reference number.

It should also be appreciated that many of the elements discussed in this specification may be implemented in hardware circuit(s), a processor executing software code, or a combination of a hardware circuit and a processor executing code. As such, the term circuit or module as used throughout this specification is intended to encompass a hardware circuit (whether discrete elements or an integrated circuit block), a processor executing code, or a combination of a hardware circuit and a processor executing code, or other combinations of the above known to those skilled in the art.

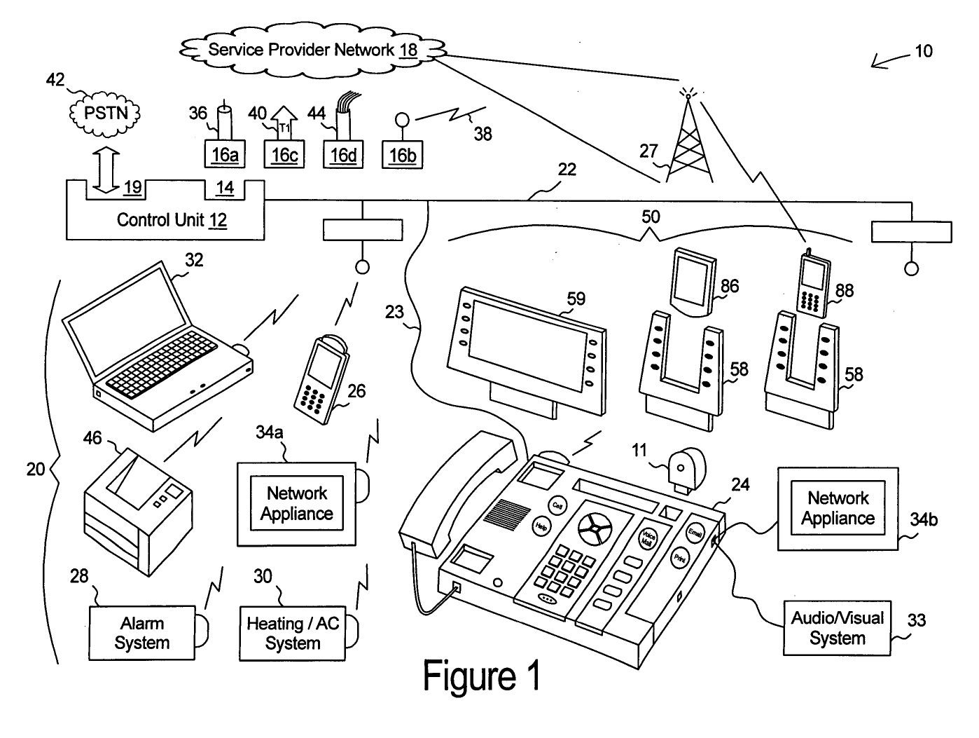

Referring to FIG. 1, an exemplary architecture of the subscriber station based management system 10 of the present invention is shown. The management system 10 includes a control unit 12 that is coupled to a plurality of external systems 20 over a wireless local area network 22 (or by a wired network connection 23 to the backbone wired network of the wireless local area network 22). The external systems 20 may include: subscriber stations 24 (subscriber stations 24), wireless dialog handsets 26, alarm systems 28, heating/air-conditioning systems 30, audio/visual systems 33, traditional computer systems 32, network printers 46, and various network appliances 34a and 34b. Some of the external systems can be coupled to the local area network 22 through a network port of the subscriber station 24.

The control unit 12 includes a circuit-switched provider bay 19 which operatively couples the control unit 12 to the public switched telephone network (PSTN) 42 and includes a multi-media communication service provider bay 14 which operatively couples the control unit 12 to a multi media service provider's network 18 through one of a plurality of communication medium modules 16a-16d.

Some illustrative examples of communication modules include: communication module 16a which may be a cable modem module for communicating over coaxial cable 36 with a multi-media communication service provider such as a local cable company, communication module 16b which may be a wide area network radio for communication over a wireless spectrum channel 38 with a wide area wireless multi-media communication service provider such as an analog or digital cellular/PCS telephone service provider, communication module 16c which may be a customer service unit (CSU) for communication over a T1 line 40 with a multi-media communication provider such as a local telephone service provider, and communication module 16d which may be an optical modem for communication over a fiber channel 44 with a fiber optic multimedia communication service provider.

With reference to both FIGS. 1 and 3, the subscriber station 24 includes a docking bay 62 into which a modular docking interface 58 may be secured and operatively coupled to the platform unit 52. The modular docking interface 58 supports one of a plurality of modular subscriber devices 50 within a subscriber device interface bay 66 and provides for operatively coupling the modular subscriber device 50 to the subscriber station 24. Exemplary configurations for the modular subscriber device 50 include a subscriber data assistant 86, a subscriber wide area network communication device 88, and a wireless LAN voice handset 26, each of which is discussed in more detail herein. Alternatively, a display device 59 may be inserted into docking bay 62.

While operatively coupled to the subscriber station 24, the subscriber device 50 becomes an integral part of the subscriber interface of the subscriber station 24. A liquid crystal graphic display 90 on the subscriber device 50 may function to display management information under control of the subscriber station 24 and the control unit 12. Further, programmable subscriber controls 92 positioned adjacent to the subscriber device 50 may be configured to activate subscriber station 24 and control unit 12 functions in accordance with the contents of the graphic display 90 adjacent to the controls 92.

In operation, the control unit 12 integrates and manages communication between two or more local communication devices 20 and between each local communication device 20 and a remote communication system(s) (not shown) coupled to either the service provider's communication network 18 or the PSTN 42. The control unit 12 also integrates and manages control of the external systems by the subscriber station 24.

In one embodiment of the invention, the control unit 12 receives a first signal from a first subscriber station 24. In response to the first signal, the control unit 12 forwards a tagged subscriber station message to the first subscriber station 24. The tagged subscriber station message is applicable to the subscriber interface of the first subscriber station. The control unit 12 then receives a second signal from the first subscriber station 24 based at least in part on the tagged subscriber station message and forwards a tagged external system message that includes a control command to at least one external system based at least in part on the second signal from the first subscriber station 24.

One embodiment of the control unit identifies a subscriber device associated with the first subscriber station. The control unit then identifies external systems that are subscriber controllable systems based at least in part on the subscriber device associated with the first subscriber station. The control unit provides display content to the first subscriber station. The display content includes menu content for a set of the subscriber controllable systems. The control unit also provides display layout control data to the first subscriber station. The display layout control data is applicable to the subscriber interface of the first subscriber station. A subscriber can then proceed to manage the subscriber controllable external system(s) as is described in further detail below.

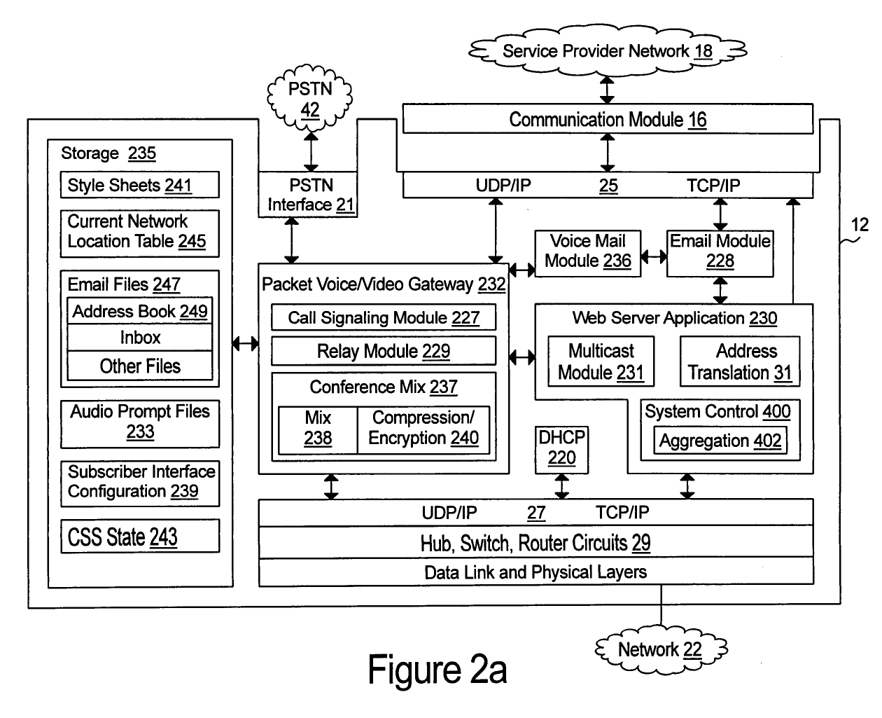

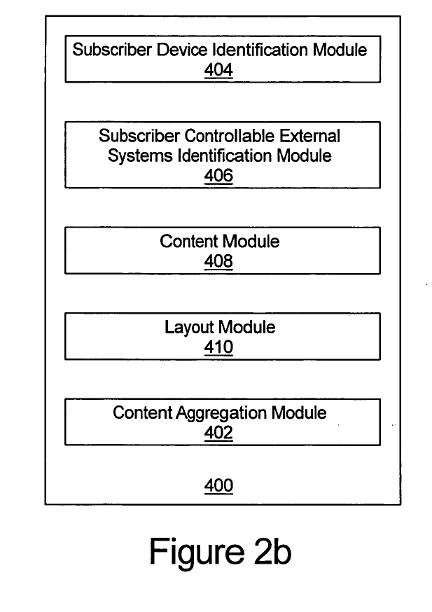

FIG. 2a shows a block diagram of an exemplary control unit 12. The control unit 12 includes applicable modules for managing the local area network 22 as an IP network. Such modules may include an applicable combination of hubs, routers, and switches 29 for managing communications over the network 22 as well as an address server 220 (e.g. DHCP server) for assigning local IP addresses to each local communication device 20.

The control unit 12 may also include a packet audio/video gateway 232, a voice mail module 236, an email module 228, and a web server application 230. The gateway 232 includes a PSTN interface module 21, a call signaling module 227, and a relay module 229. The web server application 230 includes a multicast module, an address translation module 31, and system control software 400 including an aggregation module 402. A description of the above-referenced gateway, modules, and web server application now follows.

### Packet Voice Gateway

The packet audio/video gateway 232 provides a subscriber's real time full duplex audio and audio/video call and conference call services. The services may include routing and maintaining a subscriber's outgoing calls, a subscriber's incoming calls, and a subscriber's conference calls.

A subscriber's outgoing calls are calls initiated by the subscriber utilizing a subscriber station 24. A subscriber's incoming calls are calls initiated by a remote caller to the subscriber.

Each call takes place over a real time communication session between the subscriber station 24 serving the subscriber and a remote device serving the other call participant. The remote device may be another subscriber station 24, a packet audio/video device coupled to the service provider network 18, or a PSTN device coupled to the PSTN 42.

A real time communication session between the subscriber station 24 and another subscriber station 24 or a packet audio/video device coupled to the service provider network 18 will be a voice over Internet protocol (VOIP) session with the subscriber station 24 being one endpoint of the VOIP session and the other subscriber station 24 or the packet audio/video device being the other endpoint.

A real time communication session between a subscriber station 24 and a PSTN device coupled to the PSTN 42 includes a VOIP session between the subscriber station 24 and the gateway 232 plus a PSTN session between the gateway 232 and the PSTN device. In this case, the subscriber station 24 and the gateway 232 are the two endpoints of the VOIP session and the gateway 232 and the PSTN device are the two PSTN endpoints of the PSTN session.

Establishing and managing a VOIP session between two endpoints includes exchanging session signaling messages, channel negotiation messages, compression capability messages, and optionally encryption capability and key messages between the two endpoints utilizing predetermined message protocols such as the Session Initiation Protocols (SIP) established by the Internet Engineering Task Force (IETF). The messages are exchanged utilizing user datagram protocol (UDP)/IP datagrams transferred between the two endpoints over the network 22 and the service provider network 18. The gateway 232 operates as an address directory for locating an endpoint on the local area network 22 and as an IP layer proxy for exchanging datagrams between the two endpoints.

After a VOIP session is established, communication of audio (and video) data between the two endpoints comprises compressing digital audio data into a sequence of real-time transfer protocol (RTP) frames, optionally encrypting the RTP frames, and sending the RTP frames to the other endpoint utilizing UDP/IP datagrams on the negotiated channels. At the other endpoint, the UDP/IP datagrams are received, sequenced, and the RTP frames are recovered, decrypted if applicable, and decompressed to yield the digital audio data.

Establishing a PSTN session between two PSTN endpoints includes use of standard PSTN analog or PSTN digital signaling and, after the PSTN session is established, communication of audio data between the two PSTN endpoints includes standard PSTN analog or PSTN digital communications.

A multi-party conference call initiated by the subscriber to a plurality of callee participants comprises a VOIP session between the subscriber station 24 supporting the subscriber and the gateway 232 plus a plurality of participant sessions. These participant sessions are VOIP sessions and/or PSTN sessions, each between the gateway 232 and a participating subscriber station 24, packet audio/video device coupled to the network 18, or PSTN device coupled to the PSTN 42.

The gateway 232 includes a PSTN interface module 21, a call signaling module 227, and a relay module 229.

The PSTN interface module 21 includes circuits for translating between PSTN session signaling (and analog or PSTN digital audio communication) and digital session signaling messages (and digital audio communication formats and protocols) for use by the other elements of the packet audio/video gateway 232.

The call signaling module 227 includes a routing circuit, a session signaling circuit, and a directory circuit that work in combination to provide: i) routing of a subscriber's incoming calls to a subscriber station 24 that is then serving the subscriber or to voice mail; ii) routing the subscriber's outgoing calls to another subscriber station 24, a packet audio/video device on the network 18, or to a PSTN destination; and iii) establishing calls between the gateway 232 and each conference participant. The routing circuit provides for routing session signaling messages between the two VOIP endpoints when the gateway 232 itself is not one of the endpoints. The session signaling circuit generates session signaling messages and establishes a VOIP session on behalf of the gateway 232 if the gateway 232 is an endpoint of the VOIP session being established (e.g. a session between a subscriber station 24 and a PSTN device or a conference call including the subscriber station 24).

With respect to a subscriber's outbound calls (and with respect to a subscriber's conference calls), the directory circuit receives a session signaling message, from the subscriber's subscriber station 24 (or from the conference mix module 237 if a conference call) that includes a number identifying the callee, and routes the call to the callee. The number identifying the callee may be a number representing a subscriber loop of the PSTN 42, a number identifying a person operating a packet audio/video device coupled to the network 18, or a subscriber ID representing a subscriber to the system 10.

If the number represents a packet audio/video device coupled to the network 18, the number may be permanently assigned to the device. The IP network address utilized by the device, however, may change periodically. As such, the directory circuit may query a remote directory server to determine the network address of the device (or the network address of a proxy for the device) and provide the network address to the subscriber station 24 such that it may initiate session signaling directly to the device or the proxy.

If the number represents a subscriber loop of the PSTN 42, the directory circuit provides the number to the PSTN interface 21, such that the PSTN interface circuit may establish a PSTN session with a PSTN device coupled to the subscriber loop. The directory circuit also instructs the call signaling module 227 to respond to the call signaling to establish a VOIP session between the subscriber station 24 and the gateway 232.

If the destination device is a subscriber to the system 10, steps discussed below with respect to receiving an inbound call for a subscriber are applicable.

With respect to a subscriber's inbound calls, the directory circuit receives session signaling messages from a caller device that identifies a subscriber as the callee, and routes the call to the particular subscriber station 24 that is then servicing the subscriber or, if the subscriber is not served by a subscriber station 24 or is already participating in a call, routes the call to the voice mail module 236 such that the caller may leave a message for the subscriber.

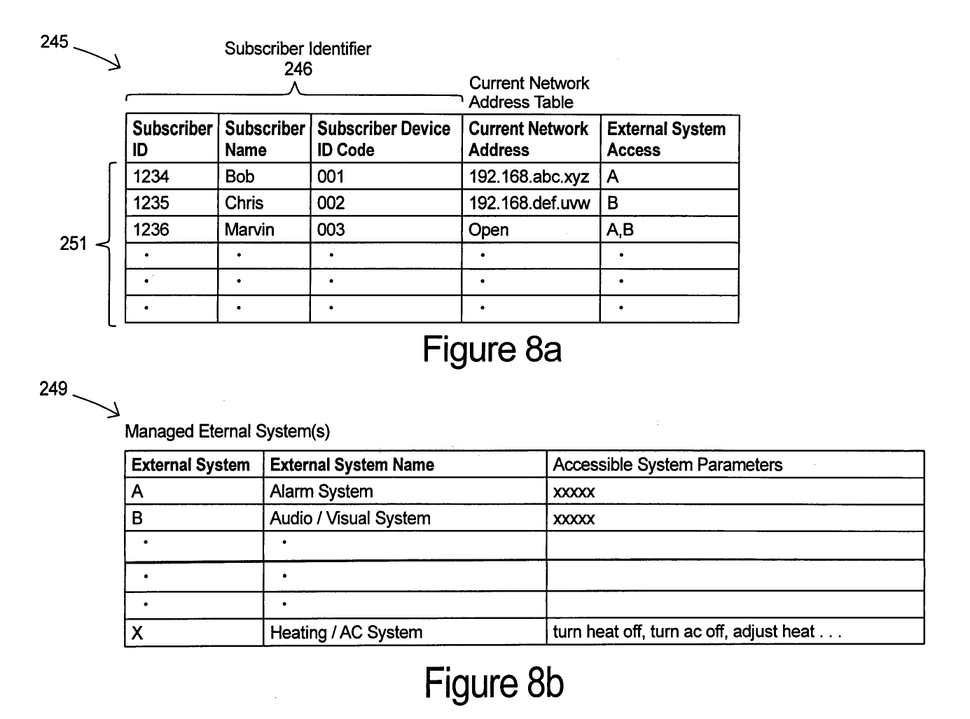

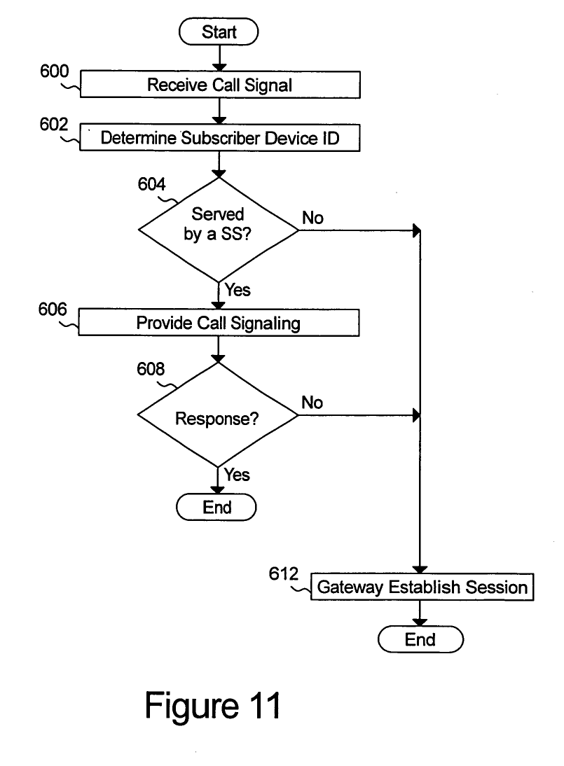

Referring to FIG. 11 in conjunction with the current network location table 245 of FIG. 8a, the process of identifying the subscriber station 24 servicing the subscriber is shown.

Step 600 represents receipt of the session signaling message identifying the subscriber. In the exemplary embodiment, each subscriber will be assigned a subscriber identifier number that corresponds to the last digits of a PSTN direct dial number that routes to the PSTN interface 21 when dialed on the PSTN. As such, the session signaling message, whether originated by a packet audio/video device coupled to network 18, a subscriber station 24 coupled to the network 22, or the PSTN interface 21 (in response to PSTN session signaling), may include the subscriber identifier number to identify the destination subscriber.

At step 602, the directory circuit identifies a subscriber device 50 (FIG. 1) that is associated with the identified subscriber utilizing the network location table 245. To associate each subscriber with his or her subscriber device 50, the network location table 245 includes a record for each subscriber. Within such record are fields that identify the subscriber, the subscriber identifier associated with the subscriber, and a subscriber device ID code that is unique to the subscriber device 50 that is assigned to the subscriber.

At step 604 the directory circuit identifies whether the subscriber's subscriber device 50 is served by a subscriber station 24. The network location table 245 further includes a field that may comprise the network address of the subscriber station 24 that is then currently serving the subscriber device 50 assigned to the subscriber. The address within this field will be updated when the subscriber moves his or her subscriber device 50 from one subscriber station 24 to another using circuits and methods discussed herein. If the subscriber device 50 is not currently served by any subscriber station 24, then the field will indicate such as represented by the term “open”.

If at step 604, the directory circuit located in the call signaling module 227 determines that the subscriber device 50 assigned to the subscriber is not currently served by any subscriber station 24, the directory circuit instructs the call signaling module 227 to establish a session on behalf of the gateway 232 such that the call signaling module couples the caller to the voice mail module 236 at step 612.

If the subscriber device is served by a subscriber station 24, however, the directory circuit at step 606 either: i) provides the network address of the subscriber station 24 to the caller device if the caller device is coupled to the local area network 22; ii) instructs the routing circuit to send the call signaling messages to the subscriber station 24 if the caller device is a packet audio/video device coupled to the network 18; or iii) instructs the session signaling circuit to respond to the session signaling and establish a VOIP session with the subscriber station if the caller device is coupled to the PSTN 42.

Step 608 represents the directory circuit determining whether the response of the subscriber station 24 is such that a communication session can be established with the subscriber station 24. In certain events, such as when the subscriber is already engaged in a call or if the subscriber does not answer the inbound call, the directory circuit will determine that a session cannot be established with the subscriber station 24 (either immediately if programmed to a “do-not-disturb” mode or after a brief time period of the subscriber station 24 ringing (either audible ringing or visual ringing) but remaining unanswered). In this case, the directory circuit instructs the call signaling module 227 to establish the session on behalf of the gateway 232 such that the caller will be coupled to the voice mail module 236 at step 612.

The relay module 229 includes circuits for operating as an IP layer proxy for VOIP sessions between a space station 24 endpoint and a packet audio/video device coupled to the network 18 endpoint.

The compression/encryption module 240 performs the translation between digital audio data and compressed RTP frames, that may be encrypted, for VOIP sessions for which the gateway 232 is itself an endpoint (e.g. sessions between a space station 24 and a PSTN device and sessions between the gateway 232 and each conference participant).

The conference mix module 237 includes an audio mixing circuit, a video routing circuit, and a conference session control circuit. The audio mixing circuit receives audio streams from each participating endpoint in the form of digital audio data provided by the compression/encryption module 240 or the PSTN interface 21 and generates digital audio data comprising one or more conference mix audio streams. The conference mix module 237 provides applicable conference mix audio streams back to each participating endpoint. It is undesirable to include the voice of a participant in the conference mix audio stream that will be returned back to such participant's endpoint because echoes could occur. As such, a single conference call may require multiple conference mix audio streams—one for each participant that excludes such participant's own voice.

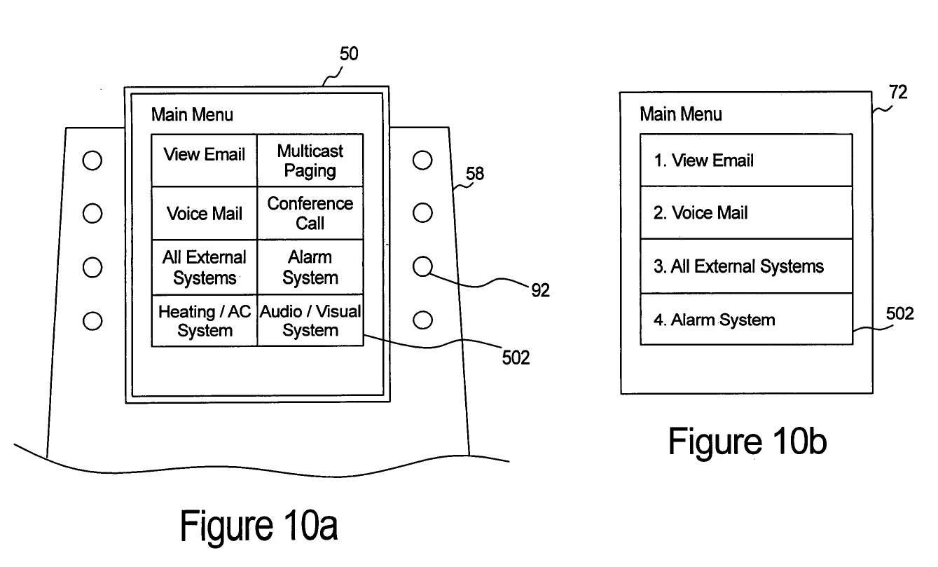

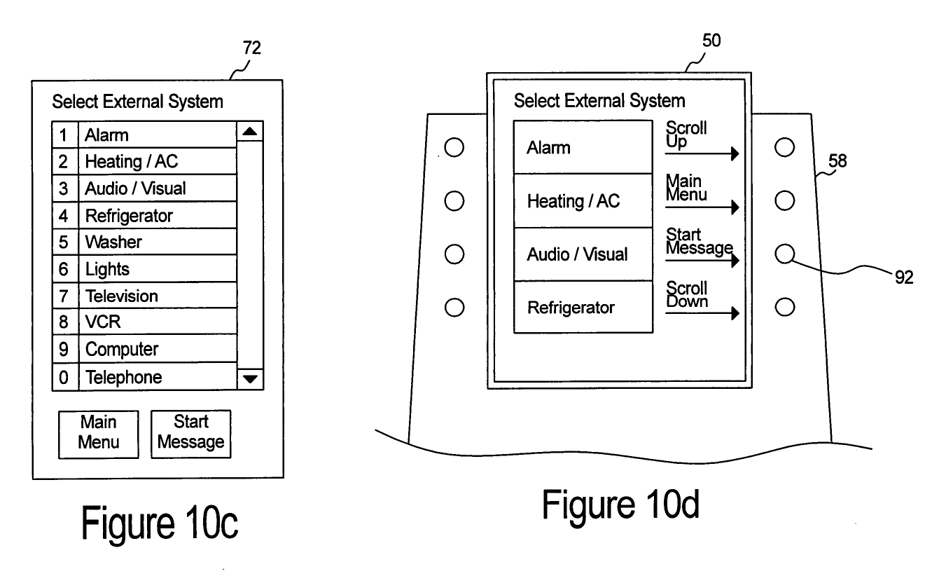

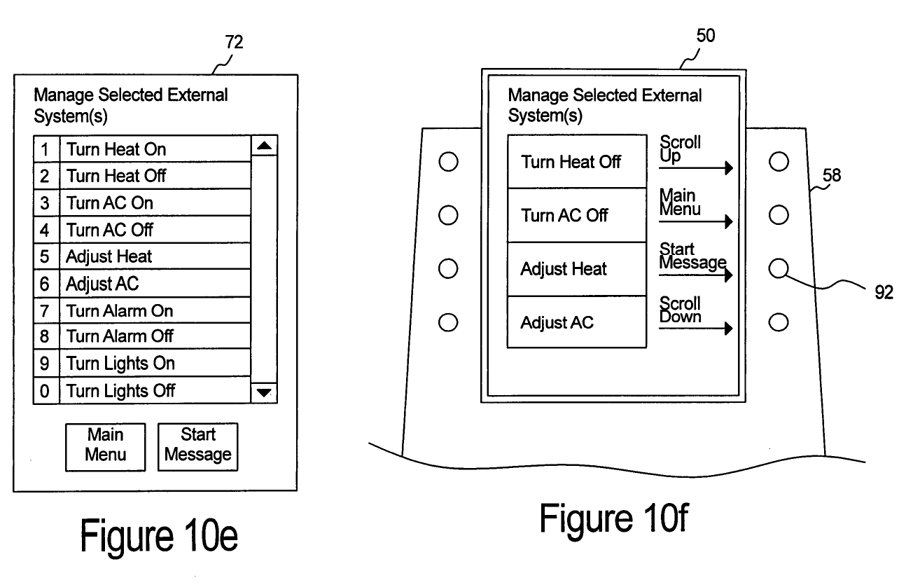

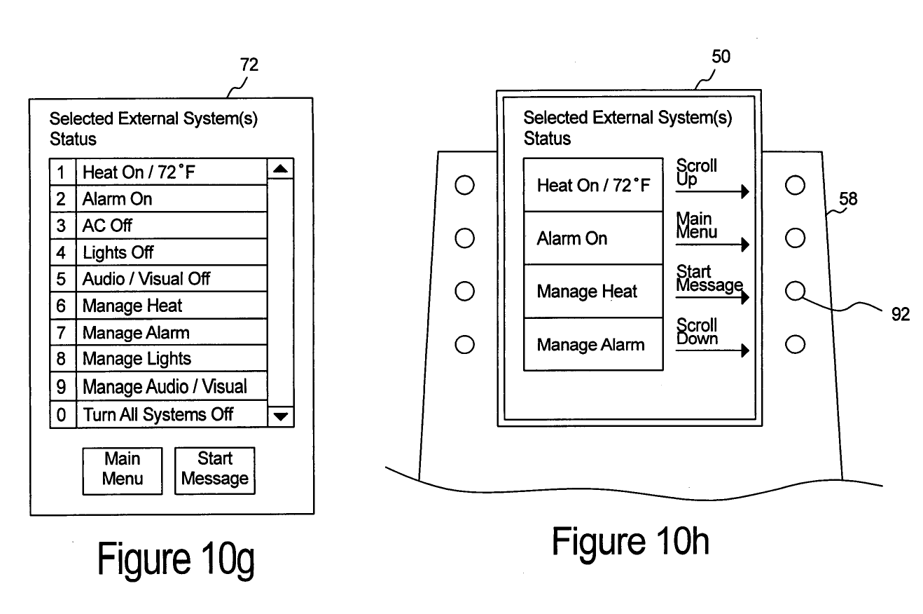

The video routing circuit receives a video stream from each participating endpoint that has video capture capabilities in the form of digital video data provided by the compression/encryption module 240. The video routing circuit also provides selected video streams back to each participating endpoint in accordance with instructions from the web server 230 discussed with respect to FIGS. 10e-10h.

The conference session control circuit receives conference set up signaling messages from an initiating space station 24 that each includes a number identifying each conference participant. The conference session control circuit provides session signaling messages to the call signaling module, each including a number identifying a conference participant, such that the call signaling module may establish a communication session between the gateway 232 and each participant.

At any time during a conference session, the conference session control circuit may receive a message from a participating endpoint instructing the conference mix module 237 to secure the conference session. In response to such message, the conference session control circuit will instruct the call signaling module 227 to generate applicable messages to begin (or continue, or at least not stop) encrypting each VOIP session comprising the conference session and to report which, if any, VOIP sessions have successfully begun encryption (or continue to be encrypted).

After receiving a report of successful encryption, the control circuit will provide signals to the web server 230 so that the web server 230 may: a) update applicable displays associated with each participating subscriber station 24 as discussed with respect to FIGS. 10e-10h; and, b) if all VOIP sessions are secure, send a message to each participating subscriber station 24 to provide for the secure button 108 to illuminate.

### Voice Mail Module

The voice mail module 236 includes circuits for providing a sequence of RTP frames representing applicable audio prompts from compressed audio prompt files 233 to the compression/encryption module 240, receiving RTP frames from the compression/encryption module 240 representing the voice of the remote caller leaving a message for the subscriber, compressing the message into a digital audio file, and sending the digital audio file to the email module 228 for storage in the email files 247 for later retrieval by the subscriber.

### Email Module

The email module 228 maintains an email account associated with each subscriber. The email module 228 includes client circuits for interfacing with a remote email server. The email module 228 logs onto an account associated with each subscriber, obtains new email messages associated with the subscriber, and sends email messages drafted by the subscriber to the remote server. The email module 228 also maintains email files 247 in the storage 235 that may include an address book and an inbox for each subscriber.

### WebServer

The web server application 230 provides additional communication services to each subscriber. Examples of the communication services provided to each subscriber by the web server application 230 include: a) management of subscriber controlled external electronic systems; b) delivery of email and voice mail messages (as emailed audio files) to the subscriber station 24 at which the subscriber's subscriber device 50 is then currently coupled; c) updating of the network location table 245 to assure proper routing of incoming audio and audio/video calls; d) proxy communication over network 18; e) delivery of multicast messages directed to a subscriber of the particular subscriber station 24 at which his or her subscriber device is then currently coupled; and f) providing subscriber control of audio and audio/video conference calls through the packet voice gateway 232.

The web server application 230 includes a multicast module 231, an address translation module 31, and system control software 400 including an aggregation module 402. The multicast module 231 provides IP multicast services to enable the web server application 230 to deliver select communications to multiple subscriber stations 24 simultaneously utilizing IP multicast protocols and without using excessive bandwidth on network 22. The address translation module 31 provides address and port translation services to enable the web server 230 to provide each subscriber station 24 with access to servers coupled to the network 18 as an IP layer proxy and without using higher layer resources of the control unit 12. One embodiment of the system control software 400 interfaces with subscriber stations to facilitate management of subscriber controllable external systems.

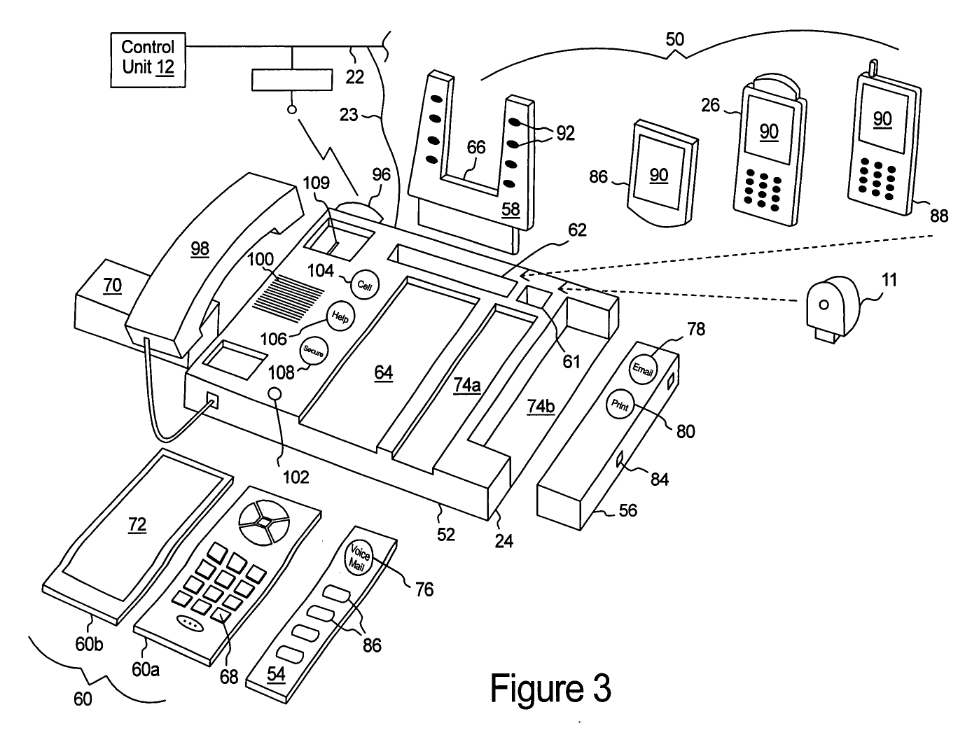

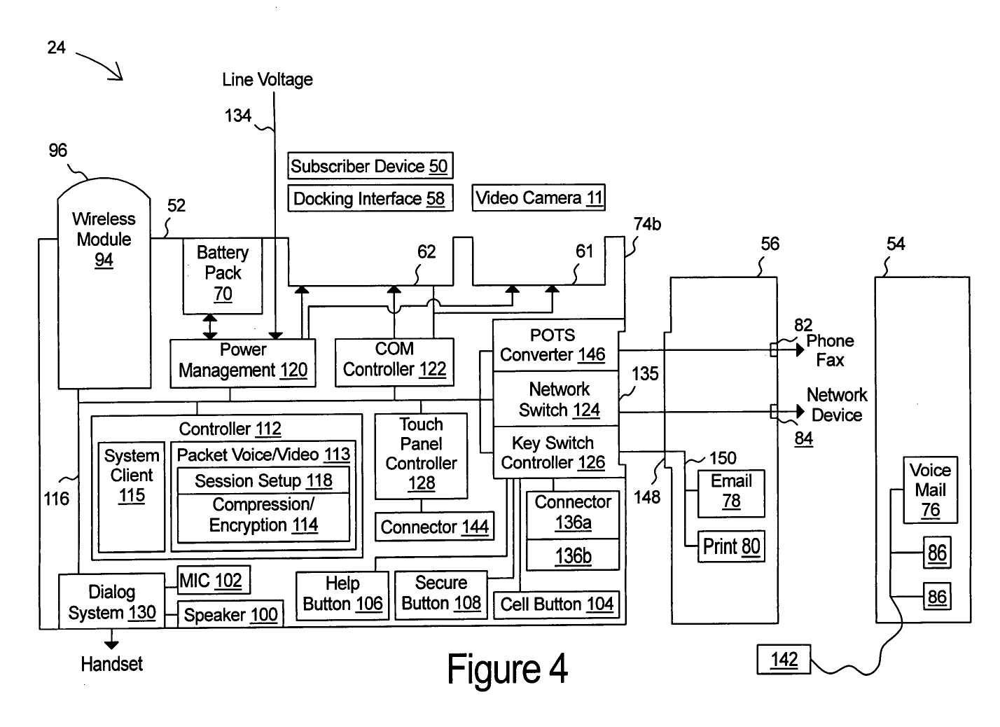

In the exemplary embodiment, non-streaming media communication between the web server application 230 and each subscriber station 24 utilizes tagged data messages over a TCP/IP session between the web server application 230 and a system client application 115 (FIG. 4) within the subscriber station 24. Each message transferred between the web server application 230 and the subscriber station 24 comprises a data element and a tag identifying the significance of the data element. For example: a) if the data element includes text describing a subscriber accessible external system, the tag would identify the data element as text, and may identify the type of text, e.g., text describing a subscriber accessible external system; b) if the data element comprises an executable script that would provide for the subscriber station 24 to perform a certain function, the tag would identify the data element as executable script and may identify the significance of the script; and c) if the data element comprises display layout control information (e.g. a style sheet) defining how another data element (such as text describing a subscriber accessible external system) should be displayed on a display screen, the tag would identify the data element as a style sheet.

Streaming media communications between the web server application 230 (such as multicast streaming media messages provided by the IP multicast module 231) and the client application 115 utilize a sequence of real-time transfer protocol (RTP) frames that include compressed media data and are sent utilizing user datagram protocol (UDP)/IP channels.

To provide communication services to each subscriber, the web server application 230 processes certain scripts in response to events generated by a subscriber station 24 and the packet audio/video gateway 232. In processing the scripts, the web server application 230 manages subscriber communication data stored in the storage 235 and provides operating instructions to the subscriber station client 24 and the email module 228.

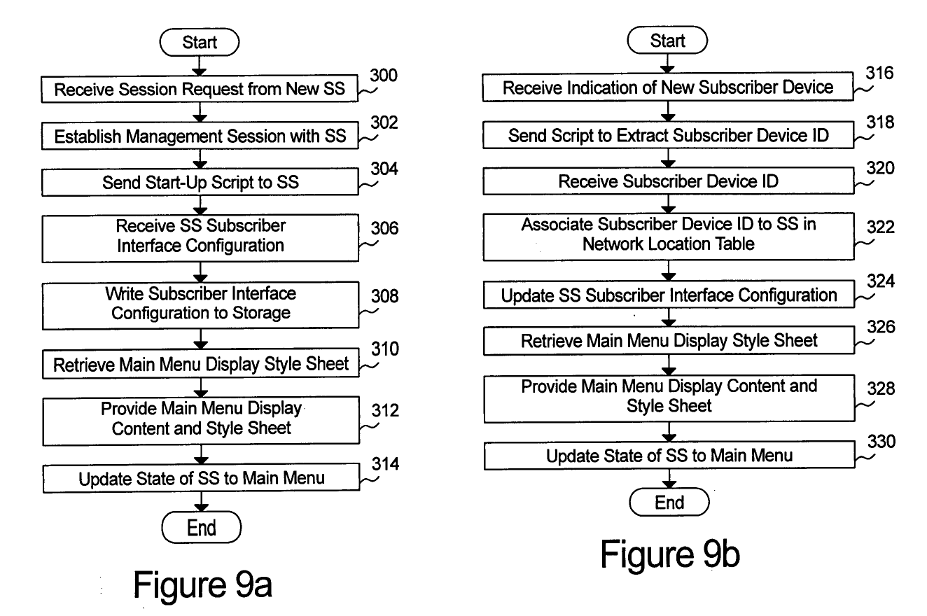

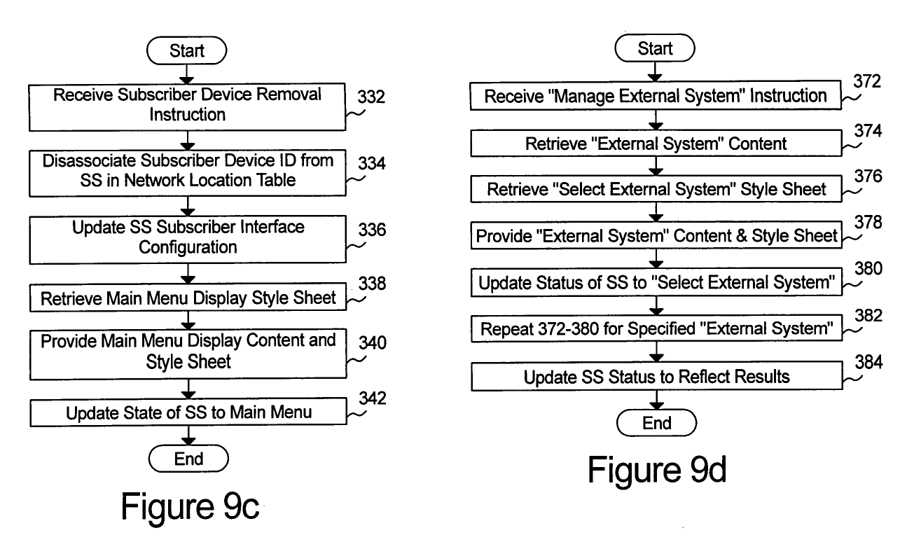

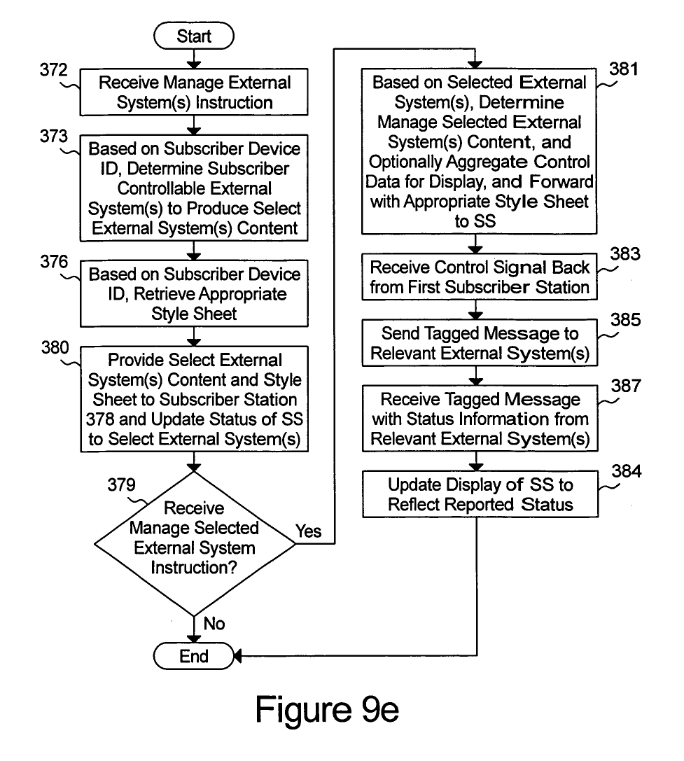

The flow charts of FIGS. 9a through 9e (which will be discussed in more detail herein) represent processing scripts that in aggregate provide for a subscriber to navigate through a layered menu to select applicable services form the control unit 12. The web server application 230 maintains state information for each subscriber station 24 such that each subscriber station 24 may navigate through the layered menu independently of other subscriber station units 24.

With reference to FIG. 2b, one embodiment of the system control software 400 includes a subscriber device identification module 404, a subscriber controllable external systems identification module 406, a content module 408, a layout module 410, and a content aggregation module 402. The subscriber device identification module 404 identifies a subscriber device associated with a first subscriber station. The subscriber controllable external systems identification module 406identifies external systems that are subscriber controllable systems based at least in part on the subscriber device associated with the first subscriber station. The content module 408 provides display content to the first subscriber station. The display content includes menu content for a set of the subscriber controllable systems. The layout module 410 provides display layout control data to the first subscriber station. The display layout control data is applicable to the subscriber interface of the first subscriber station and controls the display layout of the display content.

Thus, one embodiment of the system control software 400 interfaces with subscriber stations using tagged subscriber station messages. The first subscriber station communicates with the control unit through a network, e.g., network 22. The tagged subscriber station messages are applicable to a subscriber interface of the first subscriber station. The control software 400 receives command information back from the subscriber station. In response to the command information, the system control software forwards tagged external system messages that includes control commands to at least one external system and receives tagged external system messages that includes status information back from the at least one external system.

The content aggregation module 402 aggregates control data that facilitates control of at least two external systems. The control unit can send aggregated control data (along with layout data) to a first subscriber station for display by the subscriber interface of the first subscriber station. Thus, as an example, the control data may include information on the subscriber's alarm system and heating/air-conditioning system. In addition, the control data may provide options for turning all the systems on or off or for managing each system individually. An example of the display of aggregated external systems control data is shown in FIG. 10e. More specifically, in FIG. 10e, a subscriber device displays aggregated external system control data for an alarm system, a heating/air-conditioning system, and a light system.

### Subscriber Station

Referring to FIG. 3, a perspective view of an exemplary subscriber station 24 is shown. The subscriber station 24 includes a platform unit 52 that operatively couples to the control unit 12 via either a wireless communication link between a platform unit network circuit 96 and the wireless network 22 or a direct network connection 23 between the platform unit 52 and the backbone network of the wireless network 22.

A plurality of functional modules 54, 56, 58, 60, and 11 may be coupled to the platform unit 52 to form an integrated multi-media communication platform. The platform unit 52 includes a subscriber interface docking platform 64 for coupling and optionally supporting one of a plurality of modular subscriber interface units 60 to the platform unit 52. The modular subscriber interface unit 60a may include a plurality of buttons 68 in an arrangement similar to a typical telephone key pad to provide for subscriber input in a manner similar to that of a traditional telephone handset. The modular subscriber interface 60b may include a touch panel graphic display 72 to provide for subscriber input through virtual buttons visible thereon.

The platform unit 52 further includes a first function specific docking platform 74a and a second function specific docking platform 74b, each of which couples to respective function specific modules 54 and 56. The first function specific docking platform 74a is a shallow platform for coupling to function specific modules that primarily include function specific buttons or other circuits that may be placed within a thin module. The second function specific docking platform 74b is a larger platform for coupling to function specific modules with more complex internal circuits requiring the additional size.

In the exemplary embodiment, the function specific module 54 may include subscriber interface buttons configured for enhancing voice communication through the subscriber station 24 such as a voice message control 76 for single button access to voice message files and voice management controls 86 for single button control of enhanced voice management functions.

The function specific module 56 may include circuits configured for enhancing data communication through the subscriber station 24 such as an email control 78 for single button access to subscriber email messages, a print control 80 for single button initiation of the printing of an email message, and a data networking port 84.

As noted above, the platform unit 52 further includes a docking bay 62 into which a modular docking interface 58 may be secured and operatively coupled to the platform unit 52. The modular docking interface 58 supports one of a plurality of modular subscriber devices 50 within a subscriber device interface bay 66 and provides for operatively coupling the modular subscriber device 50 to the platform unit 52. Exemplary configurations for the modular subscriber device 50 include a subscriber data assistant 86, a subscriber wide area network communication device 88, and the wireless LAN voice handset 26, each of which is discussed in more detail herein.

While operatively coupled to the platform unit 52, the subscriber device 50 becomes an integral part of the subscriber interface of the subscriber station 24. A liquid crystal graphic display 90 on the subscriber device 50 may function to display multi-media communication management information, e.g., external system management information, under control of the platform unit 52 and the control unit 12. Further, programmable subscriber controls 92 positioned adjacent to the subscriber device 50 may be configured to activate platform unit 52 and control unit 12 functions in accordance with the contents of the graphic display 90 adjacent to the controls 92. Thus, a subscriber can control external systems by interacting with an appropriately constructed graphical display by, for example, using controls 92 or by pushing virtual buttons on a touch screen associated with subscriber device 50.

The platform unit 52 also includes docking bay 61 into which a modular video camera 11 may be coupled to the subscriber station 24. The modular video camera 11 provides a video image for use by the subscriber station 24 when participating in a video conference call.

The platform unit 52 may further include one or more of the following elements: a) a handset 98 similar to a traditional telephone handset to provide a subscriber voice interface, b) a speaker 100 and a microphone 102 to provide a hands-free subscriber voice interface, c) a modular battery pack 70 (which fits within a battery pack bay that is not shown) for operating power when the subscriber station 24 is uncoupled from a line voltage, d) cell button 104 for single button selection of certain functions such as a wide area network communication function, e) help button 106 for single button selection of a help function, and f) a secure button 108, selection of which actuates encryption of the VOIP session supporting a subscriber's call from the subscriber station 24.

FIG. 4 shows a block diagram of the subscriber station 24. The platform unit 52 includes an application controller 112 coupled to a local bus 116 that interconnects the controller 112 with a plurality of peripheral circuits that include a wireless module 94, a power management controller 120, a communication controller 122, a network switch controller 124, a key switch controller 126, a touch panel controller 128, a plain old telephone service (POTS) converter 146, and a voice communication system 130.

The wireless module 94 operatively couples the platform unit 52 with the control unit 12 over the wireless LAN 22 (both of FIG. 1). The controller 112 includes appropriate drivers for operation of the wireless module 94.

The power management controller 120 selectively receives input power from the battery pack 70 or external line voltage 134. The power management controller 120 includes appropriate circuits for converting the input power voltage to appropriate operating power required by each component of the subscriber station 24. Additionally, the power management controller 120 includes appropriate circuits for managing charging of the battery pack 70 when the platform unit 52 is coupled to the line voltage 134 and generating appropriate power for operating and/or charging the modular docking interface 58 and the modular subscriber device 50 when coupled to the platform unit 52.

The communication controller 122 operatively couples the modular docking interface 58 and the modular subscriber device 50 to the controller 112 such that the platform 52 can exchange data with the modular subscriber device 50. In the exemplary embodiment, the communication controller 122 is a serial communication controller that enables the serial exchange of data with a compatible serial communication controller within the modular subscriber device 50 over a physical medium. Exemplary physical mediums include hardwired contacts, an infrared transmission, and RF transmission, however other physical mediums are envisioned and which medium is used is not critical to this invention.

The communication control 122 also operatively couples the modular video camera 11 to the controller 112 such that the platform unit 52 may power the video camera 11 and receive the video image from the video camera 11.

The network switch controller 124 provides a network data port 84 which enables the controller 112 to communicate with another network computing circuit over a network interface. The network switch controller 124 is coupled to a bus port 135 within the function specific docking platform 74b for coupling to a mating port 148 on the function specific module 56.

The key switch (e.g. button) controller 126 is coupled to: 1) a connector 136a which in turn is coupled to a mating connector on the modular subscriber interface unit 60a (FIG. 3) for interconnecting the buttons 68 to the key switch controller 126; 2) a connector 136b which in turn is coupled to a mating connector 142 on the function specific module 54 for interconnecting the buttons 76 and 86 to the key switch controller 126; 3) the bus port 135 which in turn is coupled to a mating port 148 on the function specific module 56 for interconnecting the buttons 78 and 80 to the key switch controller 126; 4) the cell button 104; 5) the help button 106; and 6) the secure button 108. In the exemplary embodiment, the key switch controller 126 may drive row and column signals to the various buttons and, upon detecting a short between a row and a column (e.g. button activation) reports the button activation to the application controller 112 over the bus 116. Again, the application controller 112 includes appropriate drivers for operating the key switch controller 126.

The touch panel controller 128 is coupled to a connector 144 which in turn is coupled to a mating connector on the modular subscriber interface unit 60b (FIG. 3) for interconnecting the touch panel graphic display 72 to the touch panel controller 128. In the exemplary embodiment, the touch panel controller 128 may include a separate display control circuit compatible with the resolution and color depth of the touch panel graphic display 72 and a separate touch panel control circuit for detecting subscriber contact with the touch panel graphic display 72. The application controller 112 includes appropriate systems for driving the contents of the touch panel graphic display 72 through the touch panel controller 128.

The voice communication system 130 generates analog voice signals for driving the speaker 100 (or the speaker in the handset 98 of FIG. 3) and detects input from the microphone 102 (or the microphone in the handset 98) under the control of the application controller 112.

The POTS converter circuit 146 provides a standard POTS port signal (e.g. tip and ring) for operation of a traditional telephone or a traditional fax machine coupled to a POTS port 82 on the function specific module 56. In operation the POTS converter 146 circuit interfaces between the POTS signal and the application controller 112.

In the exemplary embodiment, the controller 112 executes a packet audio/video communication client 113 and a client application 115. The packet audio/video communication client 113 includes a session set up circuit 118 and a compression/encryption circuit 114.

The session set up circuit 118 provides for sending (and responding to) applicable session signaling messages to (and from) another endpoint to establish a VOIP session with such other endpoint

The compression/encryption circuit 114 exchanges the sequences of RTP frames representing compressed audio data and video data, that may be encrypted, with the other endpoint and translates between compressed and optionally encrypted RTP frames and digital audio and digital video data, that may be encrypted.

The client application 115 operates as a client to the web server application 230 (FIG. 3) within the control unit 12. The client application 115 provides for the controller 112 to: a) generate an image on the touch panel graphic display 72 or on the graphic display 90 on the subscriber device 50 in accordance with display content and a style sheet received from the control unit 12; b) output an audio stream file received from the control unit 12 through the dialog system 130; c) execute processing steps in accordance with instructions received from the control unit 12; d) provide messages indicating subscriber actions (such as subscriber activation of the cell button 104, the help button 106, a touch panel virtual button, or any other button on the subscriber station 24) to the web server application 230; e) activate the packet audio/video client 113 to set up a real time audio/video session with the packet audio/video gateway 232 (FIG. 2); f) identify the modular configuration or subscriber interface configuration of the subscriber station 24 and report the configuration to the control unit 12; and g) report the coupling of (and decoupling of) a subscriber device 50 and/or modules to the platform 52 of the subscriber station 24 to the control unit 12.

### Subscriber Data Assistant

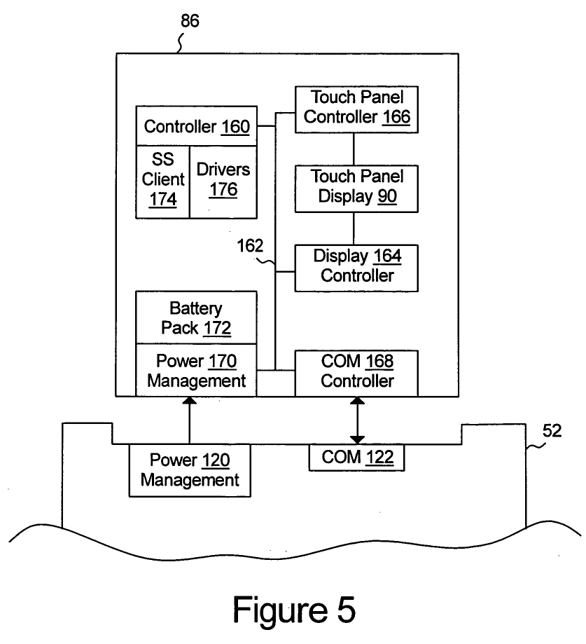

Turning to FIG. 5, exemplary structure of a subscriber data assistant 86 is shown. The subscriber data assistant 86 includes a controller 160 interconnected to a plurality of peripheral controllers by an internal bus 162. Because of the small size and the portability of the subscriber data assistant 86, the touch panel 90 provides the primary subscriber interface. A display controller 164 and a touch panel controller 166 control the touch panel 90. The display controller 164 drives the liquid crystal display of touch panel 90 using signals compatible with the resolution and color depth of the display 90. The touch panel controller 166 detects user activation of the touch panel 90. The controller 160 operates appropriate drivers 176 for controlling operation of the touch panel controller 166 and the display controller 164.

A communication controller 168 is also coupled to the bus 1 62 and operates under control of the application controller 160. In the exemplary embodiment, the communication controller 168 is a serial communication controller that is compatible with the communication controller 122 of the platform unit 52 (both of FIG. 4) such that data communication may occur between the platform unit 52 and the subscriber data assistant 86 when the subscriber data assistant 86 is operatively coupled to the platform unit 52.

A power management circuit 170 selectively receives input power from a battery pack 172 or from the power management circuit 120 in the platform unit 52. The power management circuit 170 includes appropriate circuits for converting the input power voltage to appropriate operating power required by each component of the subscriber data assistant 86. Additionally, the power management circuit 170 includes appropriate circuits for managing charging of the battery pack 172 when the subscriber data assistant is coupled to the platform unit 52.

The controller 160 also operates a subscriber station client application 174 for displaying external system management information under control of the platform unit 52 when coupled to the platform unit 52. In the exemplary embodiment the subscriber station client application 174 receives messages from the platform unit 52 in the form of tagged messages. After receipt of the tagged messages, the-subscriber station client application 174 builds a display document to display the communication management information represented by tagged content messages in accordance with a style sheet that is compatible with the size, resolution, and color depth of the touch panel display 90. The display document is then displayed on the touch panel display 90.

It should be appreciated that in addition to operating the drivers 176 and the subscriber station client application 174, the controller 160 may optionally operate any of the software applications that are commercially available for personal data assistants (PDAs) which may include address book management, calendar management, and games. While operation of such PDA applications may be useful to the subscriber, it is not critical to the operation of the present invention.

### Subscriber Wide Area Network Communication Device

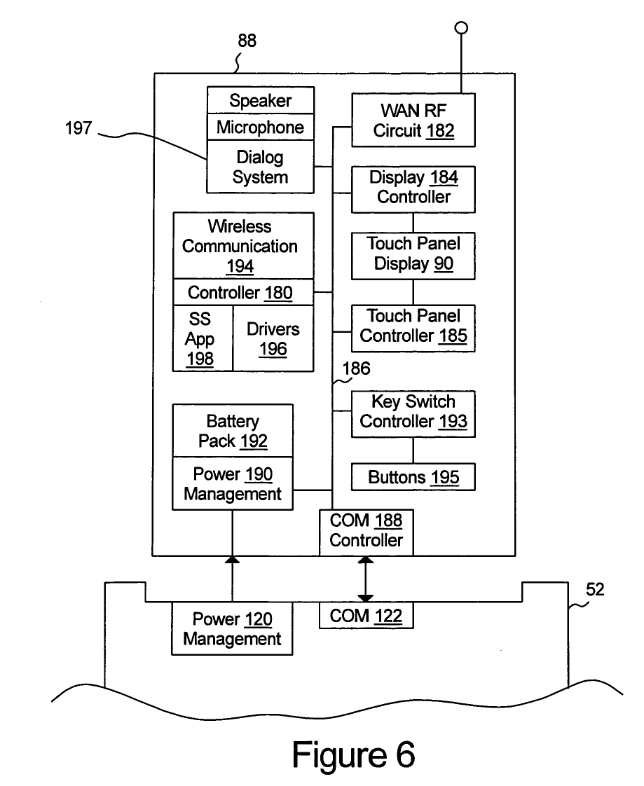

Turning to FIG. 6, exemplary structure of a subscriber wide area network communication device 88 is shown. The wide area network communication device 88 includes a controller 180 operating a Subscriber station application 198, the subscriber contact directory application 178, a wireless communication application 194, and applicable drivers 196 for a plurality of peripheral controllers. The controller 180 is interconnected to the plurality of peripheral controllers by an internal bus 186. The peripheral controllers include a wide area network RF circuit 182, a voice system 197, a display controller 184, a touch panel controller 185, a key switch controller 193, a communication controller 188, and a power management system 190.

The wide area network RF circuit 182 may be a circuit for transmitting and receiving signals from a wide area network service provider's medium under control of the wireless communication application 194. Exemplary wide area network service provider mediums include an analog or digital cellular or PCS telephone RF system.

The key switch controller 193 is coupled to the control buttons 195. The key switch controller 193 drives row and column signals to the control buttons 195 and, upon detecting a short between a row and a column indicating button activation, reports the activation to the controller 180. The control buttons may be used by a subscriber for operating the wide area network communication device 88 when uncoupled form the platform unit 52.

The voice system 197 includes a speaker and a microphone. Under control of the wireless communication application 194, the voice system 197 may provide a subscriber voice interface for an audio session with a remote device over the wide area network service provider's medium.

The display controller 184 drives the display 90 using signals compatible with the resolution and color depth of the display 90. The display 90 may optionally be a touch panel display 90 and the touch panel controller 185 detects user activation of the touch panel 90.

The communication controller 188 may be a serial communication controller compatible with the communication controller 122 in the platform unit 52 such that data communication may occur between the platform unit 52 and the wide area network communication device 88 when the wide area network communication device 88 is operatively coupled to the platform unit 52.

The power management controller 190 operates with a battery pack 192, both of which may operate in a similar manner to the power management controller 170, and the battery pack 172 discussed with reference to FIG. 5.

Similar to the subscriber data assistant 86 (FIG. 5), when the wide area network communication device 88 is coupled to the platform unit 52, the subscriber station application 198 provides for displaying multi-media communication management information under control of the platform unit 52 and provides for multi-media communication directly between the platform unit 52 and the wide area network service provider medium.

In addition the subscriber station application 198 may receive messages from the platform unit 52 which may be multi-media communication messages, e.g., external system management messages, for communication over the wide area network service provider medium. Each message includes a tag that identifies the contents of the message. After receipt of a tagged message, the subscriber station application 198 may identify whether the message is for communication with the wide area network service provider medium or whether it is external system management information for display.

When the message is for communication with the wide area network service provider medium, the subscriber station application 198 reformats the message to a format compatible with wide area network service provider medium transmission standards and transmit the message using the wide area network RF circuit 182.

The wide area network communication device 88 may also receive signals from the wide area network service provider medium via the wide area network RF circuit 182. When received, the subscriber station application 198 reformats the messages into a plurality of tagged messages for communication to the platform unit 52 and sends the tagged messages to the platform unit 52 via the communication controller 188.

### Wireless Voice Handsets

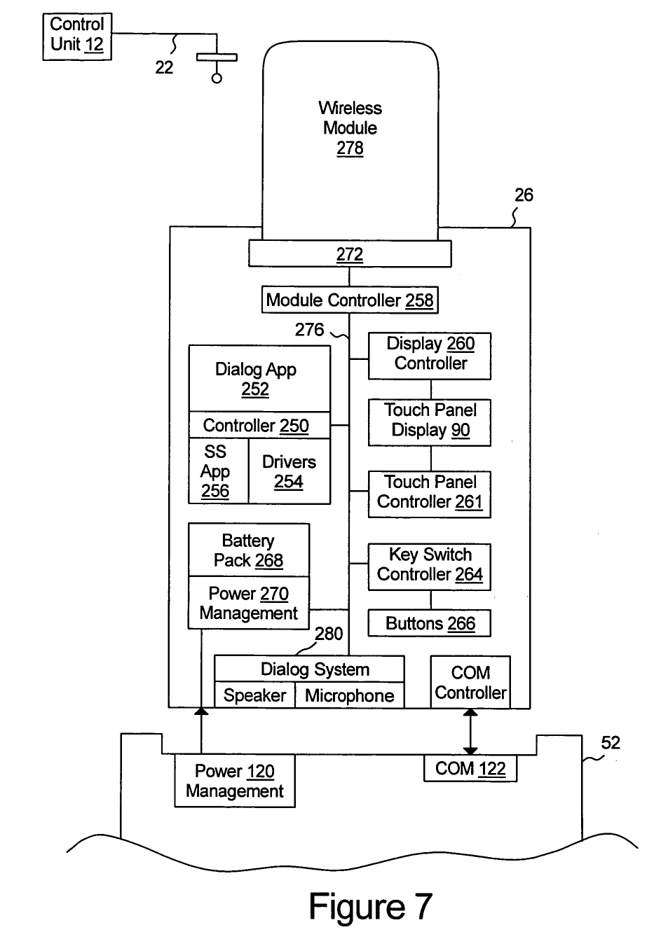

FIG. 7 shows a block diagram of an exemplary wireless dialog handset 26. The wireless voice handset 26 includes a network circuit 278 and a controller 250 that operates a subscriber station application 256, the subscriber contact directory application, a LAN communication application 252, and applicable drivers 254 for each of a plurality of peripheral controllers. A bus 276 interconnects the controller 250 to the plurality of peripheral controllers which include a module controller 258, a display driver 260, a touch panel driver 261, a key switch controller 264, and a power management circuit 270.

The module controller 258 operatively couples the network circuit 278 to the controller 250 such that the wireless voice handset 26 may communicate with the control unit 12 over the wireless LAN 22 (both of FIG. 1). In the exemplary embodiment, the module controller 258 may be a PCMCIA controller circuit and the network circuit 278 is configured as a PCMCIA card that couples to the module controller 258 through a PCMCIA connector 272. The LAN communication application 252 operates the network circuit 278 for communicating with the control unit 12 using appropriate wireless signaling protocols.

The key switch controller 264 is coupled to the control buttons 266. The key switch controller 264 drives row and column signals to the control buttons 266 and, upon detecting a short between a row and a column indicating button activation, reports the activation to the controller 250. The control buttons may be used by a subscriber for operating the wireless voice handset 26 when uncoupled form the platform unit 52.

The display controller 260 drives the display 90 (optionally a touch panel display 90) using signals compatible with the resolution and color depth of the display 90. The touch panel controller 261 detects user activation of the touch panel display 90. The power management controller 270 operates in conjunction with a battery pack 268, both of which may operate in a similar manner to the power management controller 170, and the battery pack 172 discussed with reference to FIG. 5.

When the wireless voice handset 26 is coupled to the platform unit 52, the subscriber station application 256 displays multi-media communication management information, e.g., external system management information, under control of the platform unit 52. Additionally, the subscriber station application 256 may receive external system management information content messages and control messages directly from the control unit 12 via the wireless network 22. After receipt of the tagged messages from either the platform unit 52 or the control unit 12, the subscriber station application 256 builds a document to display the external system management information represented by the tagged content messages in accordance with display layout control messages that are compatible with the size, resolution, and color depth of the touch panel display 90. The display document is then displayed on the touch panel display 90.

### Web Server Application

FIGS. 9a through 9e in conjunction with FIG. 2a show exemplary processing steps performed by the web server application 230 to provide communication services including external system management services to a subscriber station 24.

The flowchart of FIG. 9a represents steps performed by the web server application 230 upon receiving an open session request on a predetermined port from a subscriber station 24 that has just been operatively coupled to the network 22, obtained a network address from the network address server 220, and is ready to operate as a client to the web server application 230. Step 300 represents receipt of the open session request and step 302 represents establishing a TCP/IP session with the subscriber station 24.

Step 304 represents sending a start up script to the subscriber station 24. The start up script includes instructions that, when executed by the client application 115, provide for the subscriber station 24 to detect its subscriber interface configuration (e.g. whether the subscriber station 24 includes a display screen and what capabilities such as video capabilities and graphic resolution capabilities the display screen may have) and to report its subscriber interface configuration back to the web server application 230.

Step 306 represents receipt of the subscriber interface configuration of the subscriber station 24 from the subscriber station 24 and step 308 represents writing an indication of the subscriber interface configuration of the subscriber station 24 to a subscriber interface table 239 in the storage 235.

Step 310 represents retrieving a main menu display style sheet from a selection of style sheets 241 stored in the storage 235. The retrieved main menu display style sheet will be a style sheet that corresponds to the subscriber interface configuration of the subscriber station 24.

Step 312 represents providing main menu display content and the style sheet to the subscriber station 24 and step 314 represents updating a subscriber station state table 243 in the storage 235 to indicate that the subscriber station 24 is in a main menu state.

It should be appreciated that the main menu content provided to the subscriber station 24 is independent of the subscriber interface, however, the style sheet provided to the subscriber station 24 is dependent on the subscriber interface. For example, turning to FIG. 10a which represents display of a main menu on a subscriber device 50 in the modular docking interface 58 the content of the main menu display includes a title of main menu and choices of view email, voice mail, multi cast paging, conference call, manage all external systems, manage alarm system, manage heating/air-conditioning system, and manage audio/visual system. The style sheet corresponding to a subscriber interface that includes a subscriber device 50 provides for the content to be graphically displayed with the title at the top and each menu choice to be displayed adjacent a button 92 on the modular docking interface 58.

Alternatively, turning to FIG. 10b which represents display of a main menu on a display 72 that is coupled to a subscriber station interface 64 (FIG. 3), the content of the main menu display again includes a title of main menu and the choices of view email, voice mail, manage all external systems and manage alarm system. However, the style sheet that corresponds to a subscriber interface that includes a display 72 that is coupled to a subscriber station interface 64 provides for the content to be graphically displayed with the title at the top and each choice to be displayed in a vertical list with an adjacent numeral for selection using the keypad 68 (FIG. 3). The examples shown in FIGS. 10a and 10b are for illustrative purposes only. Other subscriber interface configurations that include non-graphic displays, bit mapped multi line text displays, or 7 element single or multi line text displays may utilize different style sheets for displaying all or a portion of the main menu content.

The flowchart of FIG. 9b represents steps performed by the web server application 230 upon receiving an indication that a subscriber device 50 has been coupled to a subscriber station 24. Step 316 represents receipt of such indication.

Step 318 represents sending a device ID extraction script to the subscriber station 24. The device ID extraction script includes instructions that, when executed by the client application 115, provide for the subscriber station 24 to interrogate the subscriber device 50 to determine its device identification (e.g. an identification of which subscriber to which the device has been assigned) and to report the device identification back to the web server application 230.

Step 320 represents receipt of the device identification back from the subscriber station 24 and step 322 represents associating the device ID with the subscriber station 24 in the network location table 245 in the storage 235. The web server application 230 utilizes the network location table 245 for authorizing management access to a particular subscriber station 24 at which a subscriber's subscriber device 50 is then currently coupled. It should be appreciated that this step 322 provides for the network location table 245 to properly indicate association between a subscriber station 24 and the subscriber device 50 that is served thereby.

Because the style sheet selected for display of content on the subscriber station 24 is dependent on the subscriber interface configuration of the subscriber station 24 as determined by the subscriber interface table 239, the table should be updated when the subscriber interface configuration changes. Coupling a subscriber device 50 to a subscriber station 24 changes the subscriber interface because the display of the subscriber device 50 becomes a display for the subscriber station 24. As such, step 324 represents updating the subscriber interface configuration of the subscriber station 24 in the subscriber interface table 239.

Step 326 represents retrieving a main menu display style sheet that is applicable to the new subscriber interface configuration from the selection of style sheets 241 in the storage 235 and step 328 represents providing main menu display content and the style sheet to the subscriber station 24. Step 330 represents updating the subscriber station state table 243 to assure that it represents that the subscriber station 24 is in the main menu state.

The flow chart of FIG. 9c represents steps performed by the web server application 230 upon receiving an indication that a subscriber device 50 has been removed from a subscriber station 24. Step 322 represents receipt of such an indication.

Because the web server application 230 may utilize the network location table 245 for alerting a particular subscriber station 24 at which a subscriber's subscriber device 50 is then currently coupled regarding external system status, the network location table 245 should be updated upon removal of a subscriber device 50 from a subscriber station 24. Step 334 represents disassociating the subscriber device 50 from the subscriber station 24 in the network location table 245.

Because the display on the subscriber device 50 is no longer part of the subscriber interface of the subscriber station 24 after the subscriber device 50 is removed, step 336 represents updating the subscriber interface configuration table 239.

Step 338 represents retrieving a main menu display style sheet that is applicable to the subscriber interface configuration without the subscriber device 50 from the selection of style sheets 241 in the storage 235 and step 340 represents providing main menu display content and the style sheet to the subscriber station 24. Step 342 represents updating the subscriber station state table 243 to assure that it represents that the subscriber station 24 is in the main menu state.

The flowchart of FIG. 9d represents steps performed by the web server application 230 upon receiving a subscriber indication of a command to manage external system(s). The subscriber station 24 may detect such a subscriber indication by various means, such as touch panel activation of button activation of a menu selection on the main menu, dependent on the subscriber interface configuration of the subscriber station 24. Step 372 represents the web server application 230 receiving the subscriber indication of a command to manage external system(s).

Step 374 represents retrieving the subscriber's select external system(s) content. Step 376 represents retrieving a select external system(s) style sheet that corresponds to the subscriber interface of the subscriber station 24 and step 378 represents providing both the select external system(s) content and the select external system(s) style sheet to the subscriber station 24. Step 380 represents updating the subscriber station state table 243 to indicate that the subscriber station 24 is in the select external system(s) state. Step 382 represents repeating steps 372 to 380 for a specified or selected external system(s). Step 384 represents updating the subscriber station state table 243 to indicate the subscriber station 24 is in the manage selected external system(s) state.

FIG. 10c represents an exemplary display of the select external system(s) content utilizing a style sheet that is applicable to a display 72 wherein the subscriber may use buttons or a touch panel to select one or more external system(s) to manage. It should be appreciated that some external systems may be listed individually and others may be subsumed within a group of external systems. Because the list of groups included in the external systems content may be larger than can be displayed on the display 72, the style sheet may provide for only a portion of the content to be displayed along with touch activated scroll controls for display of the remainder of the content. The style sheet may further include touch activated controls to return to the main menu.

FIG. 10d represents an exemplary display of the select external system(s) content utilizing a style sheet that is applicable to a display of a subscriber device 50 coupled in the modular docking interface 58. Because subscriber selection is to be by activation of buttons 92, the style sheet provides for the content to be displayed with the groups on the left side for selection by buttons 92 on the left side of the modular docking interface 58 and for indicators to label the function of the buttons 92 on the right side of the modular docking interface 58 such as scroll up, scroll down, start message, and return to main menu.

FIG. 9e expands on the steps provided in FIG. 9d. Once the control unit receives 372 a manage external system(s) instruction, the control unit, based on the subscriber device ID, determines subscriber controllable external system(s), and uses this information to create Select External System(s) content. Also based on the subscriber ID, the control unit retrieves 376 an appropriate style sheet.

The control unit provides 378 the Select External System(s) content and an appropriate style sheet to the subscriber station and updates 380 the status of the subscriber station to Select External System(s). If the control unit does not receive a selection in response to the display of the Select External System(s) content, the process terminates. If the control unit receives a selection, based on the selected external system(s), the control unit determines 381 Manage Selected External System(s) content. The control unit can derive the content from a Manage External System(s) table 249 shown in FIG. 8b.

Optionally, the aggregation module 402 of the control unit can aggregate control data for more than one external system for display on a common screen of the subscriber interface of the subscriber station. The control unit then forwards the Manage Selected External System(s) content with the appropriate style sheet to the subscriber station. For example, with reference to FIG. 2b, the subscriber controllable external systems identification module 406, using a subscriber device ID, first obtains a list of subscriber accessible systems from table 245 in FIG. 8a. Using the list of subscriber accessible external systems, the content module 408 can then obtain a list of accessible parameters for those systems from table 249 in FIG. 8b to produce content for display. The content aggregation module 402 can then aggregate the content provided by the content module 408 to provide content that facilitates control of at least two external systems, e.g., as shown in FIG. 10e. The control unit then forwards the (potentially aggregated) Manage Selected External System(s) content with an appropriate style sheet to the appropriate subscriber station.

In response to the display of the Manage Selected External System(s) content, the control unit receives 383 a control signal back from the subscriber station. The control unit then sends 385 a tagged message to the relevant external system(s). The control unit can receive 387 a tagged message with status information back from relevant external system(s). Finally the control unit can update 384 the display of the subscriber station.

Updating the display of the subscriber station can include displaying status information for one or more external system(s) on the subscriber station. Furthermore, the aggregation module 402 can aggregate status information from more than one external system. The control unit can then forward the aggregated status information with an appropriate style sheet to a subscriber station for display. For example, with reference to FIG. 10g, the subscriber station displays status information regarding the heating/air-conditioning system, the alarm system, the lighting system and the audio/visual system. In addition, the display provides options for managing these systems or for turning all the systems off. FIG. 10h shows a display for a different subscriber device 50. This display shows the status of the heating and alarm systems and allows the user to select options for managing the heating system, managing the alarm system, or scrolling down to view the status of other systems or to view further selections.

In other words, according to these steps, the control unit accesses the list of systems that a subscriber (identified by his or her subscriber device via the table of FIG. 8) can control and assembles and forwards control content for the subscriber's display. The control unit also forwards a style sheet appropriate for the subscriber's display.

The systems and methods of the invention provide external system management services to subscribers. Although the invention has been shown and described with respect to certain preferred embodiments, equivalents and modifications will occur to others skilled in the art upon the reading and understanding of the specification. Those skilled in the art may envision other processing states, events, and processing steps to further the objectives of the modular external system management system of the invention. For example, invention contemplates the management of a wide variety of external system parameters, such as monitoring and adjusting operating levels. The invention also contemplates a wide variety of user interfaces for facilitating such management. The invention includes all such equivalents and modifications, and is limited only by the scope of the following claims.

Other embodiments are within the scope and spirit of the appended claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A control system for controlling external systems coupled to a local area network, the control system comprising:
a control unit coupled to the local area network, the control unit comprising system control software operative to forward a tagged external system message that includes a control command to at least one external system and to receive a tagged external system message that includes status information back from the at least one external system upon query from the control unit; and
a first subscriber station in communication with the control unit, the first subscriber station operative to interface with the control unit using tagged subscriber station messages, the tagged subscriber station messages being applicable to a subscriber interface of the first subscriber station.

2. The system of claim 1, wherein the tagged subscriber station messages are HTML documents.

3. The system of claim 1, wherein the tagged subscriber station messages are XML messages.

4. The system of claim 1, wherein the tagged external system messages are XML messages.

5. The system of claim 1, wherein the control unit further comprises:
control unit aggregation means for aggregating control data that facilitates control of at least two external systems, the control data capable of being concurrently displayed on a common screen by the subscriber interface of the first subscriber station.

6. The system of claim 5, wherein the control unit further comprises:
means for identifying a subscriber device associated with the first subscriber station;
means for identifying external systems that are subscriber controllable systems based at least in part on the subscriber device associated with the first subscriber station;
means for providing display content to the first subscriber station, the display content including menu content for a set of the subscriber controllable systems; and
means for providing display layout control data to the first subscriber station, the display layout control data being applicable to the subscriber interface of the first subscriber station.

7. The system of claim 1, wherein the system further comprises:
a second subscriber station in communication with the control unit, the second subscriber station operative to interface with the control unit using tagged subscriber station messages, the tagged subscriber station messages being applicable to a subscriber interface of the second subscriber station.

8. The system of claim 1, wherein the control unit further comprises:
an aggregation module operative to aggregate control data that facilitates control of at least two external systems, the control data capable of being concurrently displayed on a common screen by the subscriber interface of the first subscriber station.

9. The system of claim 8, wherein the control unit further comprises:
a subscriber device identification module operative to identify a subscriber device associated with the first subscriber station;
a subscriber controllable external systems identification module coupled to the subscriber device identification module and operative to identify external systems that are subscriber controllable systems based at least in part on the subscriber device associated with the first subscriber station;
a content module coupled to the subscriber controllable external systems identification module and operative to provide display content to the first subscriber station, the display content including menu content for a set of the subscriber controllable systems; and
a layout module coupled to the subscriber device identification module and operative to provide display layout control data to the first subscriber station, the display layout control data being applicable to the subscriber interface of the first subscriber station.

10. A control unit for facilitating the control of external systems, the control unit and the external systems being coupled to a local area network, the control unit comprising:
system control software operative to interface with a first subscriber station using tagged subscriber station messages, the first subscriber station in communication with the control unit through a network, the tagged subscriber station messages being applicable to a subscriber interface of the first subscriber station, the system control software operative to forward a tagged external system message that includes a control command to at least one external system and to receive a tagged external system message that includes status information back from the at least one external system.

11. The control unit of claim 10, wherein the tagged subscriber station messages are HTML documents.

12. The control unit of claim 10, wherein the tagged subscriber station messages are XML messages.

13. The control unit of claim 10, wherein the tagged external system messages are XML messages.

14. The control unit of claim 10, wherein the control unit further comprises:
control unit aggregation means for aggregating control data that facilitates control of at least two external systems, the control data capable of being concurrently displayed on a common screen by the subscriber interface of the first subscriber station.

15. The control unit of claim 14, wherein the control unit further comprises:
means for identifying a subscriber device associated with the first subscriber station;
means for identifying external systems that are subscriber controllable systems based at least in part on the subscriber device associated with the first subscriber station;
means for providing display content to the first subscriber station, the display content including menu content for a set of the subscriber controllable systems; and
means for providing display layout control data to the first subscriber station, the display layout control data being applicable to the subscriber interface of the first subscriber station.

16. The system of claim 10, wherein the control unit further comprises:
an aggregation module operative to aggregate control data that facilitates control of at least two external systems, the control data capable of being concurrently displayed on a common screen by the subscriber interface of the first subscriber station.

17. The system of claim 16, wherein the control unit further comprises:
a subscriber device identification module operative to identify a subscriber device associated with the first subscriber station;
a subscriber controllable external systems identification module coupled to the subscriber device identification module and operative to identify external systems that are subscriber controllable systems based at least in part on the subscriber device associated with the first subscriber station;
a content module coupled to the subscriber controllable external systems identification module and operative to provide display content to the first subscriber station, the display content including menu content for a set of the subscriber controllable systems; and
a layout module coupled to the subscriber device identification module and operative to provide display layout control data to the first subscriber station, the display layout control data being applicable to the subscriber interface of the first subscriber station.

18. In a control unit coupled to a local area network, a method for controlling external systems coupled to the local area network, the method comprising:
receiving a first signal from a first subscriber station;
responsive to the first signal, forwarding a tagged subscriber station message to the first subscriber station, the tagged subscriber station message being applicable to the subscriber interface of the first subscriber station;
receiving a second signal from the first subscriber station based at least in part on the tagged subscriber station message; and
forwarding a tagged external system message that includes a control command to at least one external system based at least in part on the second signal from the first subscriber station.

19. The method of claim 18, wherein the method further comprises:
after forwarding a tagged external system message to the at least one external system, receiving a tagged external system message that includes status information back from the at least one external system.

20. The method of claim 19, wherein the method further comprises:
responsive to the tagged external system message that includes status information, forwarding a second tagged subscriber station message to the first subscriber station, the second tagged subscriber station message including the status information.

21. The method of claim 19, wherein the tagged external system messages are XML messages.

22. The method of claim 18, wherein the tagged subscriber station messages are HTML documents.

23. The method of claim 18, wherein the tagged subscriber station messages are XML messages.

24. The method of claim 18, wherein receiving a first signal comprises:
based at least in part on the first signal, determining if the first subscriber station is associated with a subscriber with control access to the at least one external system; and
if the first subscriber station is associated with a subscriber with control access, forwarding a tagged subscriber station message to the first subscriber station, the tagged subscriber station message being applicable to the subscriber interface of the first subscriber station;
else, forwarding an access-denied signal to the first subscriber station indicating that the first subscriber station is not associated with a subscriber with control access.

25. The method of claim 24, wherein determining if the first subscriber station is associated with a subscriber with control access comprises:
determining a subscriber identification associated with a subscriber using the first subscriber station; and
based on the subscriber identification, determining whether the subscriber has control access.

26. The method of claim 18, wherein the method further comprises:
identifying a subscriber device associated with the first subscriber station;
identifying external systems that are subscriber controllable systems based at least in part on the subscriber device associated with the first subscriber station;
providing display content to the first subscriber station, the display content including menu content for a set of the subscriber controllable systems; and
providing display layout control data to the first subscriber station, the display layout control data being applicable to the subscriber interface of the first subscriber station.
